(19) United States
(12) Patent Application Publication
(10) Pub. No.: US 2011/0205239 A1
(43) Pub. Date: Aug. 25, 2011

(54) METHOD AND APPARATUS FOR GENERATING COLOR INFORMATION

(75) Inventor: Ji Woo LEE, Gumi-si (KR)

(73) Assignee: SAMSUNG ELECTRONICS CO. LTD., Suwon-si (KR)

(21) Appl. No.: 13/009,355

(22) Filed: Jan. 19, 2011

(30) Foreign Application Priority Data
Feb. 23, 2010 (KR) 10-2010-0015957

(51) Int. Cl. G09G 5/02

(52) U.S. Cl. 345/589

(57) ABSTRACT

An apparatus and method for generating color information in a mobile device is provided. The apparatus detects at least two target colors and then calculates a cyan (C) coordinate, a magenta (M) coordinate, and a yellow (Y) coordinate of each detected target color in a CMY coordinate system. Also, the apparatus generates mixed color information about a mixed color of the target colors, being based on the C coordinate, the M coordinate and the Y coordinate of each target color. A method is further provided to generate color information in the mobile device.

### PRIORITY

This application claims the benefit under 35 U.S.C. § 119(a) of a Korean patent application filed on Feb. 23, 2010 in the Korean Intellectual Property Office and assigned Ser. No. 10-2010-0015957, the entire disclosure of which is hereby incorporated by reference.

### BACKGROUND OF THE INVENTION

1. Field of the Invention:

The present invention relates to the technology of generating color information. More particularly, the present invention relates to generating mixed color information in a mobile terminal.

2. Description of the Related Art:

The CMY coordinate system is a color coordinate system used to represent a color. The CMY coordinates describe the amounts of cyan (C), magenta (M), and yellow (Y) in order to create a particular color. When these primary colors C, M, and Y used in the CMY coordinate system are combined, they subtract all colors of light, reducing the brightness of a mixed color. This is therefore referred to as subtractive color mixture.

The RGB coordinate system, another color coordinate system, is based on red (R), green (G), and blue (B). When these primary colors R, G, and B used in the RGB coordinate system are combined, they increase the brightness of a mixed color. This is therefore referred to as additive color mixture.

### SUMMARY OF THE INVENTION

An aspect of the present invention is to address at least the above-mentioned problems and/or disadvantages and to provide at least the advantages described below.

According to an aspect of the present invention, an apparatus for generating color information in a mobile device is provided. The apparatus includes a detection unit for detecting at least two target colors, a CMY calculation unit for calculating a cyan (C) coordinate, a magenta (M) coordinate, and a yellow (Y) coordinate of each detected target color in a CMY coordinate system having a C region, an M region, and a Y region, and a mixed color generation unit for generating mixed color information about a mixed color of the target colors, based on the C coordinate, the M coordinate, and the Y coordinate of each target color.

According to another aspect of the present invention, a method for generating color information in a mobile device is provided. The method includes, detecting at least two target colors, calculating a cyan (C) coordinate, a magenta (M) coordinate, and a yellow (Y) coordinate of each detected target color in a CMY coordinate system having a C region, an M region, and a Y region, and generating mixed color information about a mixed color of the target colors, based on the C coordinate, the M coordinate, and the Y coordinate of each target color.

An aspect of the present invention is to provide a mixed color of at least two target colors by calculating the C, M, and Y coordinates of each target color and then generating color information about the mixed color, being based on the calculated C, M, and Y coordinates.

Another aspect of the present invention is to allow a user to conveniently see a mixed color by processing the C, M, and Y coordinates with a weight factor determined for each of the target colors.

Aspects of the present invention may be widely applied to various fields such as educations, medical services, industries, etc. by offering mixed color information in enhanced manners.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a concept diagram illustrating a process of generating a mixed color from two different colors in accordance with an exemplary embodiment of the present invention.

FIG. 2 is a block diagram illustrating an apparatus for generating color information in a mobile device in accordance with an exemplary embodiment of the present invention.

FIG. 3 is a flow diagram illustrating a method for generating color information in a mobile device in accordance with an exemplary embodiment of the present invention.

FIG. 4 is a flow diagram illustrating a detailed process of generating mixed color information in accordance with an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding, but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention is provided for illustration purposes only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Hereinafter, a mobile device (or often referred to as a user terminal, etc.) will be exemplarily used to describe an apparatus and method for generating color information in accordance with an exemplary embodiment of the present invention. The mobile device may include, but is not limited to, a terminal dedicated to offering of color information, a cellular phone, a computer, any kind of device capable of being attached or connected thereto, or their various equivalents.

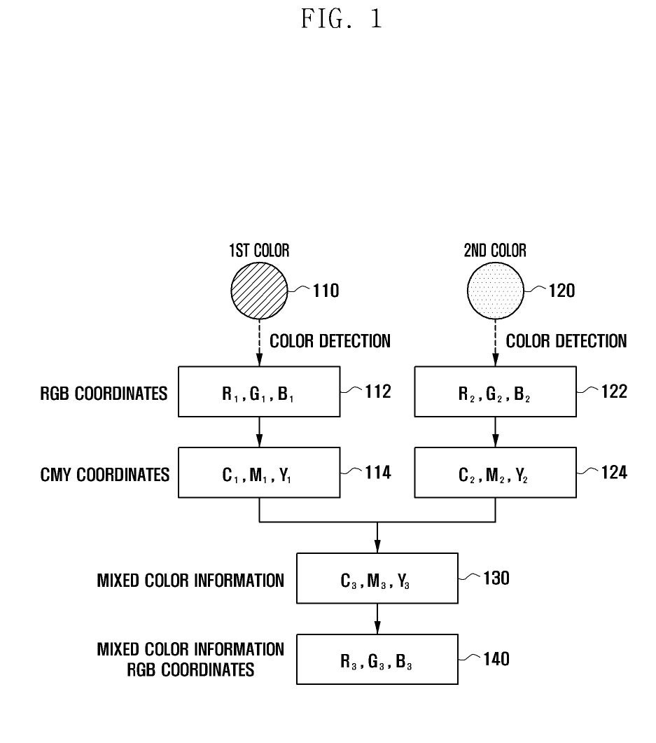

FIG. 1 is a concept diagram illustrating a process of generating a mixed color from two different colors in accordance with an exemplary embodiment of the present invention.

As discussed above, one way of representing a color is to use the CMY coordinate system that has a cyan (C) region, a magenta (M) region, and a yellow (Y) region. Another way of representing a color is to use the RGB coordinate system that has a red (R) region, a green (G) region, and a blue (B) region.

The mobile device detects a color by respectively sensing the first color 110 and the second color 120. From the first color 110, the mobile device detects R, G, and B coordinates (R₁, G₁, B₁), indicated by a reference number 112, in the RGB coordinate system. The mobile device performs a coordinate transformation from the detected R, G, and B coordinates (R₁, G₁, BO to C, M, and Y coordinates (C₁, M₁, Y₁), indicated by a reference number 114, in the CMY coordinate system. From the second color 120, the mobile device detects R, G and B coordinates (R₂, G₂, B₂), indicated by a reference number 122, in the RGB coordinate system. The mobile device performs a coordinate transformation from the detected R, G, and B coordinates (R₂, G₂, B₂) to C, M, and Y coordinates (C₂, M₂, Y₂), indicated by a reference number 124, in the CMY coordinate system.

In order to obtain the C, M, and Y coordinates (C₁, M₁, Y₁) 114 and the C, M, and Y coordinates (C₂, M₂, Y₂) 124, the mobile device may use Equation 1 given below. Based on Equation 1, the mobile device may perform a coordinate transformation from R, G, and B coordinates in the RGB coordinate system to C, M, and Y coordinates in the CMY coordinate system.

C₀=1−(R₀/255)

M₀=1−(G₀/255)

Y₀=1−(B₀/255) [Equation 1]

Here, R₀, G₀, and B₀ denote the R, G and B coordinates of a detection target color, namely, each of the first and second colors 110 and 120. C₀, M₀, and Y₀ denote the C, M, and Y coordinates of the detection target color.

Based on the C, M, and Y coordinates (C₁, M₁, Y₁) 114 and the C, M, and Y coordinates (C₂, M₂, Y₂) 124, the mobile device generates color information about a mixed color of the first and second colors 110 and 120. (C₃, M₃, Y₃) indicated by a reference number 130 are C, M, and Y coordinates in the CMY coordinate system that show mixed color information.

The mobile device may determine a weight factor of each of the first and second colors 110 and 120. The mobile device generates the mixed color information by processing the C, M, and Y coordinates (C₁, M₁, Y₁) 114 and the C, M, and Y coordinates (C₂, M₂, Y₂) 124 with their weight factors.

The weight factor denotes information that indicates a mixing ratio of the first and second colors 110 and 120. The weight factor may be predefined as a default value or inputted by a user. In the former case, the weight factor of each color may be predefined as 0.5. Accordingly, the sum of weight factors is 1. In the latter case, the mobile device may determine the weight factor through information about a mixing ratio which may be appropriately adjusted by a user.

The mobile device multiplies each of the C, M, and Y coordinates by the weight factor determined for each color. The mobile device adds up the multiplied C coordinates in the C region, adds up the multiplied M coordinates in the M region, and adds up the multiplied Y coordinates in the Y region.

Based on Equation 2 below, the mobile device may generate color information about a mixed color of the first and second colors 110 and 120.

C₃=C₁×α+C₂×β

M₃=M₁×α+M₂×β

Y₃=Y₁×α+Y₂×β [Equation 2]

Here, α+β=1, 0<α<1, 0<β<1. In addition, C₁, M₁, and Y₁ denote the C, M, and Y coordinates 114 of the first color 110 in the CMY coordinate system, and C₂, M₂, and Y₂ denote the C, M, and Y coordinates 124 of the second color 120 in the CMY coordinate system. C₃, M₃, and Y₃ denote the C, M, and Y coordinates 130 of the mixed color in the CMY coordinate system.

For example, when each of the weight factors α and β is 0.5, the mixed color information (C₃, M₃, Y₃) 130 may be obtained by calculating, with regard to each of the C, M, and Y regions, an arithmetic average of the C, M, or Y coordinate (C₁, M₁, Y₁) 114 of the first color 110 and the C, M, or Y coordinate (C₂, M₂, Y₂) 124 of the second color 120.

According to another exemplary embodiment of the present invention, the mobile device may calculate the mixed color information (C₃, M₃, Y₃) 130 by subtracting, with regard to each of the C, M, and Y regions, half of a difference between the C, M, or Y coordinate 114 of the first color 110 and the C, M, or Y coordinate 124 of the second color 120 from a relatively greater C, M or Y coordinate. An example is shown in Equation 3 given below.

If C₁>C₂, C₃=C₁−{(C₁−C₂)/2}

If M₁<M₂, M₃=M₂−{(M₂−M₁)/2}

If Y₁<Y₂, Y₃=Y₂−{(Y₂−Y₁)/2} [Equation 3]

According to another exemplary embodiment of the present invention, the mobile device may calculate the mixed color information (C₃, M₃, Y₃) 130 by adding, with regard to each of the C, M, and Y regions, half of a difference between the C, M, or Y coordinate 114 of the first color 110 and the C, M, or Y coordinate 124 of the second color 120 to a relatively smaller C, M, or Y coordinate.

According to another exemplary embodiment of the present invention, the mobile device may generate the mixed color information by inputting the C, M, and Y coordinates of each of the first and second colors 110 and 120 into a predefined function or mapping table. A predefined function may be a linear function, a quadratic function, a higher-order function, or a filter by which mixed color information is produced from two or more color coordinates in each of the C, M, and Y regions. A mapping table may define in advance, based on statistics data, a relation between inputted two or more color coordinates and mixed color coordinates. The above-discussed techniques may be expanded to other cases of mixing three or more target colors.

For example, when mixing a third color to a mixed color of two colors, the mobile device may detect the third color, obtain the R, G, and B coordinates of the third color, and obtain the C, M, and Y coordinates of the third color according to one of the above-discussed techniques. The mobile device may generate color information about a newly mixed color of the mixed color information (C₃, M₃, Y₃) 130 and C, M, and Y coordinates (C₄, M₄, Y₄) of the third color based on the above-discussed techniques, for example, based on Equation 2 or 3. Alternatively, after obtaining the C, M, and Y coordinates (C₁, M₁, Y₁) 114 of the first color, the C, M, and Y coordinates (C₂, M₂, Y₂) 124 of the second color, and the C, M, and Y coordinates (C₄, M₄, Y₄) of the third color, the mobile device may calculate color information about a mixed color of three colors by multiplying the C, M, and Y coordinates (C₄, M₄, Y₄) by a weight factor γ for the third color and adding each of the multiplied C, M, and Y coordinates to Equation 2 in each of the C, M, and Y regions. Here, α+β+γ=1, 0<α<1, 0<β<1, 0<γ<1. Accordingly, the mobile device may generate mixed color information about a mixed color of three or more colors.

The mixed color information (C₃, M₃, Y₃) 130 is transformed into R, G, and B coordinates (R₃, G₃, B₃) 140 of a mixed color so that the mobile device can display the mixed color on the screen. In order to visually offer the mixed color to a user through a display unit, the mobile device may transform the generated color information (C₃, M₃, Y₃) 130 about the mixed color into the R, G, and B coordinates suitable for the display unit. In a process of transforming the mixed color information into the R, G, and B coordinates, the mobile device may use Equation 4, varying from Equation 1, given below.

R₃=(1=C₃)×255

G₃=(1=M₃)×255

B₃=(1=Y₃)×255 [Equation 4]

Consequently, the display unit of the mobile device offers an image to a user through the R, G, and B coordinates of the mixed color information.

According to other exemplary embodiments of the present invention, the mobile device may offer the mixed color information to a user in other suitable forms. For example, the mobile device may display at least one of the C, M, and Y coordinates (C₃, M₃, Y₃) 130 themselves and the R, G, and B coordinates (R₃, G₃, B₃) 140 themselves. The mobile device may also display or offer as auditory information a color name according to a color name table that defines a mapping between the color name and the CMY or RGB coordinates. The mobile device may also send the mixed color information (C₃, M₃, Y₃) 130 to any kind of output device such as a printer.

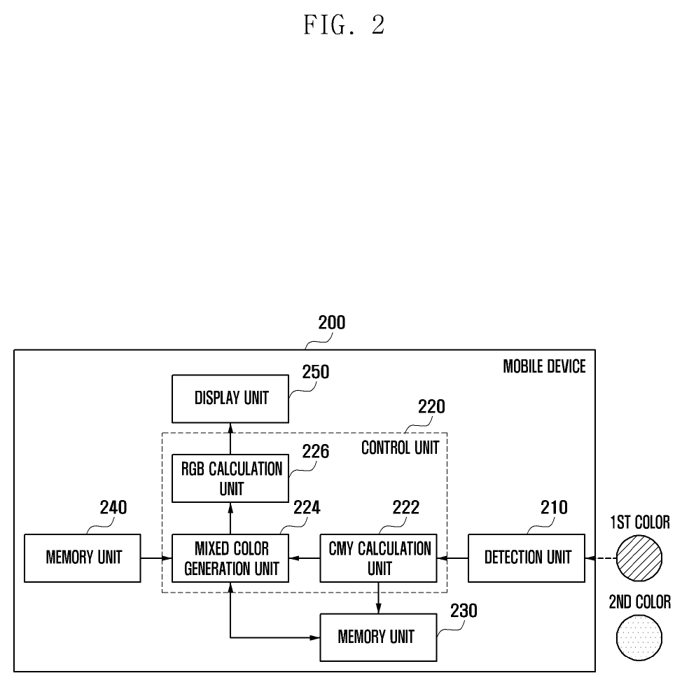

FIG. 2 is a block diagram illustrating an apparatus for generating color information in a mobile device in accordance with an exemplary embodiment of the present invention.

Referring to FIG. 2, the apparatus 200 of the mobile device includes a detection unit 210, a control unit 220, a memory unit 230, an input unit 240, and a display unit 250. The control unit 220 includes a CMY calculation unit 222, a mixed color generation unit 224, and an RGB calculation unit 226. The mobile device may include additional units. Similarly, the functionality of two or more of the above units may be integrated into a single component.

The detection unit 210 may include a color sensor that performs a sequential sensing of at least two colors in order to detect R, G, and B coordinates of each color in the RGB coordinate system having R, G, and B regions. The color sensor recognizes the intensities of R, G, and B colors through photodiodes equipped therein and thereby detects the R, G, and B coordinates in the RGB coordinate system. In order to detect R, G, and B coordinates of each color in the RGB coordinate system having R, G, and B regions, the detection unit 210 may directly receive a user's input of the R, G, and B coordinates or may find the R, G, and B coordinates in a mapping with a particular color selected by a user among colors displayed in the display unit 250.

The CMY calculation unit 222 performs a coordinate transformation from the detected R, G, and B coordinates to C, M, and Y coordinates in the CMY coordinate system. A process of this coordinate transformation is described above. If the detection unit 210 can directly detect the C, M, and Y coordinates from a target color, the CMY calculation unit 222 may be omitted.

The memory unit 230 stores the calculated C, M, and Y coordinates when there is a color to be mixed.

The mixed color generation unit 224 generates color information about a mixed color of at least two colors from the C, M, and Y coordinates of each color. The mixed color generation unit 224 may read the C, M, and Y coordinates previously stored in the memory unit 230 and, based on the C, M, and Y coordinates received from the CMY calculation unit 222, generate the mixed color information. As discussed earlier in FIG. 1, a process of generating the mixed color information includes processing at least one of the C, M, and Y coordinates with the weight factor of each of at least two colors. The mixed color generation unit 224 multiplies each of the C, M, and Y coordinates by the weight factor determined for each color and then adds up the multiplied coordinates in each of the C, M, and Y regions. This corresponds to a technique of using Equation 2 discussed earlier in FIG. 1. The weight factor may be predefined as a default value or inputted by a user.

The input unit 240 receives a user's input for the weight factor of each color. In addition, the input unit 240 may be used to receive a user's input for the R, G, and B coordinates as discussed earlier in the detection unit 210.

As described in FIG. 1, the mixed color generation unit 224 may generate the mixed color information by inputting the C, M, and Y coordinates of each of at least two colors into a predefined function or mapping table. If there is any color to be further mixed, the mixed color generation unit 224 stores the mixed color information in the memory unit 230. If the mixed color information generated earlier is to be used, the mixed color generation unit 224 retrieves the mixed color information from the memory unit 230.

The RGB calculation unit 226 calculates the R, G, and B coordinates of a mixed color from the mixed color information generated by the mixed color generation unit 224. The mixed color information is the C, M, and Y coordinates in the CMY coordinate system. A process of this coordinate transformation is described above.

Although the above exemplary embodiment separately describes the CMY calculation unit 222, the mixed color generation unit 224, and the RGB calculation unit 226, the control unit 220 according to another exemplary embodiment of the present invention may perform all functions of the CMY calculation unit 222, the mixed color generation unit 224 and the RGB calculation unit 226 without separation.

The display unit 250 performs an image processing for the R, G, and B coordinates of the mixed color information and offers a resultant mixed color to a user. In some exemplary embodiments of the present invention, at least one of the RGB calculation unit 226 and the display unit 250 may be omitted according to types of offering the mixed color information to a user or depending on types of the mobile device.

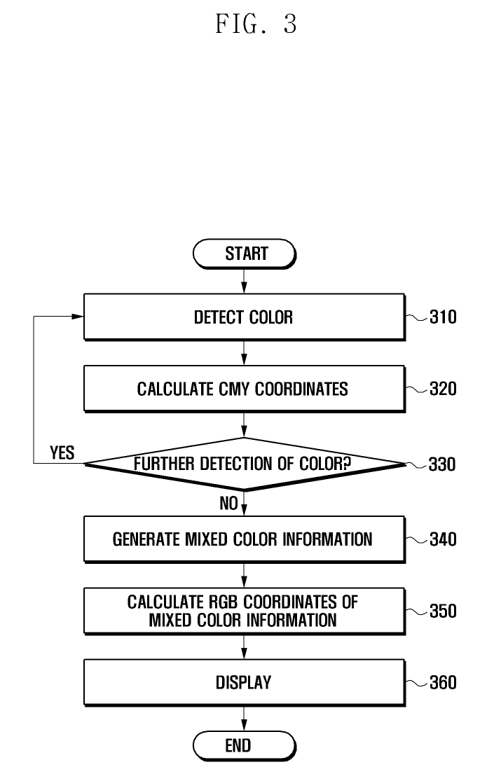

FIG. 3 is a flow diagram illustrating a method for generating color information in a mobile device in accordance with an exemplary embodiment of the present invention.

Referring to FIG. 3, the mobile device detects the R, G, and B coordinates of the first color in the RGB coordinate system in step 310. From the detected R, G, and B coordinates, the mobile device calculates the C, M, and Y coordinates in the CMY coordinate system in step 320. The mobile device determines whether to further detect the R, G, and B coordinates of another color in step 330. If a further detection is needed, the mobile device returns to the previous step 310 and then detects the R, G, and B coordinates of the second color.

If no further detection is needed, the mobile device generates color information about a mixed color of at least two target colors from the C, M, and Y coordinates of the at least two target colors in step 340. If it is determined in step 330 that the third color information is previously stored or that the mixed color information about at least two colors is stored, the mobile device may use the stored color information in the step 340 without any further detection. The determination in the step 330 may depend on whether a user will further input another color or will use the stored colors.

According to another exemplary embodiment of the present invention, the mobile device may perform the determination in step 330 according to a prearranged criterion. For example, if the number of colors to be mixed is set for two, the step 330 may be replaced with determining whether the C, M, and Y coordinates of two colors to be mixed are inputted. Directions of yes and no may be set conversely.

In step 350, the mobile device calculates the R, G, and B coordinates of the mixed color in the RGB coordinate system based on the mixed color information generated in step 340. The mobile device displays the mixed color on the display unit using the calculated R, G, and B coordinates in step 360.

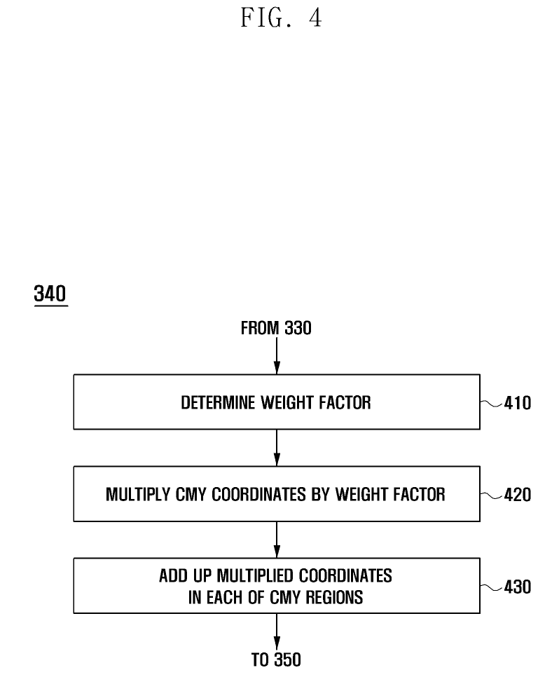

FIG. 4 is a flow diagram illustrating a detailed process of generating mixed color information in accordance with an exemplary embodiment of the present invention. The process of generating mixed color information will be described in the context of step 340 shown in FIG. 3 for convenience of explanation.

Referring to FIG. 4, if no further detection is needed in step 330, the mobile device determines the weight factors of target colors to be mixed in step 410. As discussed above, the weight factor may be predefined as a default value or inputted by a user. The weight factor is information that indicates a mixing ratio of at least two colors. The mobile device multiplies each of the C, M, and Y coordinates by the weight factor determined for each color in step 420. The mobile device adds up the multiplied coordinates in each of the C, M, and Y regions in step 430. Based on Equation 2 above, the mobile device generates color information about a mixed color of at least two colors. In this fashion, the mobile device generates the C, M, and Y coordinates as mixed color information through the steps 410 to 430 corresponding to step 340.

In step 340, the mobile device may calculate the mixed color information by subtracting, with regard to each of the C, M, and Y regions, half of a difference between the C, M, or Y coordinates of the target colors from a relatively greater C, M, or Y coordinate. The mobile device may calculate the mixed color information by adding, with regard to each of the C, M, and Y regions, half of a difference between the C, M, or Y coordinates of the target colors to a relatively smaller C, M, or Y coordinate. The mobile device may generate the mixed color information by inputting the C, M, and Y coordinates of each target color into a predefined function or mapping table.

The above-described method according to exemplary embodiments of the present invention may be executed by computer program instructions. Since these program instructions may be included in a general purpose computer, in a special processor or in programmable or dedicated hardware, instructions executed therein may create means for implementing functions discussed above. As would be understood in the art, the computer, the processor, or the programmable hardware include memory components that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. The program instructions and the media may be those specially designed and constructed for the purposes of the present invention, or they may be of the kind well-known and available to those skilled in the art of computer software arts.

While this invention has been shown and described with reference to certain exemplary embodiment thereof, it will be understood by those skilled in the art that various changes in form and details may be made therein without departing from the spirit and scope of the invention as defined by the appended claims and their equivalents.

What is claimed is:

1. An apparatus for generating color information in a mobile device, the apparatus comprising:
a detection unit for detecting at least two target colors;
a CMY calculation unit for calculating a cyan (C) coordinate, a magenta (M) coordinate, and a yellow (Y) coordinate of each detected target color in a CMY coordinate system having a C region, an M region, and a Y region; and
a mixed color generation unit for generating mixed color information about a mixed color of the target colors, based on the C coordinate, the M coordinate and the Y coordinate of each target color.

2. The apparatus of claim 1, further comprising:
an RGB calculation unit for calculating a red (R) coordinate, a green (G) coordinate, and a blue (B) coordinate of each detected target color in an RGB coordinate system having an R region, a G region, and a B region.

3. The apparatus of claim 1, wherein the mixed color generation unit generates the mixed color information by processing at least one of the C coordinate, the M coordinate, and the Y coordinate with a weight factor determined for each of the target colors.

4. The apparatus of claim 3, wherein the mixed color generation unit multiplies each of the C coordinate, the M coordinate, and the Y coordinate by the weight factor for each of the target colors and adds up the multiplied coordinates in each of the C region, the M region, and the Y region.

5. The apparatus of claim 3, wherein the mixed color generation unit generates the mixed color information based on an equation given below:
C₃=C₁×α+C₂×β
M₃=M₁×α+M₂×β
Y₃=Y₁×α+Y₂×β,
wherein α+β=1, 0<α<1, 0<β<1, wherein C₁, M₁, and Y₁ denote the C coordinate, the M coordinate, and the Y coordinate of a first target color of the at least two target colors in the CMY coordinate system, wherein C₂, M₂, and Y₂ denote the C coordinate, the M coordinate, and the Y coordinate of a second target color of the at least two target colors in the CMY coordinate system, and wherein C₃, M₃, and Y₃ denote the C coordinate, the M coordinate, and the Y coordinate of the mixed color in the CMY coordinate system.

6. The apparatus of claim 3, wherein the weight factor is predefined as a default value or inputted by a user.

7. The apparatus of claim 1, wherein the mixed color generation unit generates the mixed color information by inputting the C coordinate, the M coordinate, and the Y coordinate of each target color into a predefined function or mapping table.

8. The apparatus of claim 1, wherein the detection unit comprises a color sensor for performing a sequential sensing of the target colors so as to detect a red (R) coordinate, a green (G) coordinate, and a blue (B) coordinate of the each target color in an RGB coordinate system having an R region, a G region, and a B region.

9. The apparatus of claim 1, wherein the CMY calculation unit performs a coordinate transformation from a red (R) coordinate, a green (G) coordinate, and a blue (B) coordinate of each detected target color in an RGB coordinate system to the C coordinate, the M coordinate, and the Y coordinate in the CMY coordinate system.

10. The apparatus of claim 9, wherein the CMY calculation unit performs the coordinate transformation from the R coordinate, the G coordinate, and the B coordinate in the RGB coordinate system to the C coordinate, the M coordinate, and the Y coordinate in the CMY coordinate system based on an equation given below:
C₀=1−(R₀/255)
M₀=1−(G₀/255)
Y₀=1−(B₀/255)
wherein R₀, G₀ and B₀ denote the R coordinate, the G coordinate and the B coordinate of each target color, and wherein C₀, M₀ and Y₀ denote the C coordinate, the M coordinate and the Y coordinate of each target color.

11. A method for generating color information in a mobile device, the method comprising:
detecting at least two target colors;
calculating a cyan (C) coordinate, a magenta (M) coordinate, and a yellow (Y) coordinate of each detected target color in a CMY coordinate system having a C region, an M region, and a Y region; and
generating mixed color information about a mixed color of the target colors, based on the C coordinate, the M coordinate, and the Y coordinate of each target color.

12. The method of claim 11, further comprising:
calculating a red (R) coordinate, a green (G) coordinate, and a blue (B) coordinate of the each detected target color in an RGB coordinate system having an R region, a G region, and a B region.

13. The method of claim 11, wherein the generating of the mixed color information comprises generating the mixed color information by processing at least one of the C coordinate, the M coordinate, and the Y coordinate with a weight factor determined for each of the target colors.

14. The method of claim 13, wherein the generating of the mixed color information comprises:
multiplying each of the C coordinate, the M coordinate, and the Y coordinate by the weight factor for each of the target colors; and
adding up the multiplied coordinates in each of the C region, the M region, and the Y region.

15. The method of claim 13, wherein the generating of the mixed color information comprises generating the mixed color information based on an equation given below:
C₃=C₁×α+C₂×β
M₃=M₁×α+M₂×β
Y₃=Y₁×α+Y₂×β,
wherein α+β=1, 0<α<1, 0<β<1, wherein C₁, M₁, and Y₁ denote the C coordinate, the M coordinate, and the Y coordinate of a first target color of the at least two target colors in the CMY coordinate system, wherein C₂, M₂, and Y₂ denote the C coordinate, the M coordinate, and the Y coordinate of a second target color of the at least two target colors in the CMY coordinate system, and wherein C₃, M₃, and Y₃ denote the C coordinate, the M coordinate, and the Y coordinate of the mixed color in the CMY coordinate system.

16. The method of claim 13, wherein the weight factor is predefined as a default value or inputted by a user.

17. The method of claim 11, wherein the generating of the mixed color information comprises generating the mixed color information by inputting the C coordinate, the M coordinate, and the Y coordinate of each target color into a predefined function or mapping table.

18. The method of claim 11, wherein the detecting of the at least two target colors comprises performing a sequential sensing of the target colors in order to detect a red (R) coordinate, a green (G) coordinate, and a blue (B) coordinate of the each target color in an RGB coordinate system having an R region, a G region, and a B region.

19. The method of claim 11, wherein the calculating of the C coordinate, the M coordinate, and the Y coordinate comprises performing a coordinate transformation from a red (R) coordinate, a green (G) coordinate, and a blue (B) coordinate of each detected target color in an RGB coordinate system to the C coordinate, the M coordinate, and the Y coordinate in the CMY coordinate system.

20. The method of claim 19, wherein the calculating of the C coordinate, the M coordinate, and the Y coordinate comprises performing the coordinate transformation from the R coordinate, the G coordinate, and the B coordinate in the RGB coordinate system to the C coordinate, the M coordinate, and the Y coordinate in the CMY coordinate system based on an equation given below:
C₀=1−(R₀/255)
M₀=1−(G₀/255)
Y₀=1−(B₀/255),
wherein R₀, G₀, and B₀ denote the R coordinate, the G coordinate, and the B coordinate of each target color, and wherein C₀, M₀, and Y₀ denote the C coordinate, the M coordinate, and the Y coordinate of each target color.
